(19) United States
(12) Patent Application Publication
(10) Pub. No.: US 2026/0211444 A1
(43) Pub. Date: Jul. 23, 2026

(54) KNOB ASSEMBLY FOR A COOKING APPLIANCE

(71) Applicant: Haier US Appliance Solutions, Inc., Wilmington, DE (US)

(72) Inventor: Paul Bryan Cadima, Crestwood, KY (US)

(21) Appl. No.: 19/026,928

(22) Filed: Jan. 17, 2025

(51) Int. Cl. G05G 1/04; F24C 15/00; G05G 5/05

(52) U.S. Cl. CPC G05G 1/04; F24C 15/00; G05G 5/05; G05G 2505/00

(57) ABSTRACT

A knob assembly for an appliance may include a knob switch disposed behind a surface panel. The knob switch may include an internal spring and a slidable stem extended through the central axis. The slidable stem may be in forward-biased mechanical communication with the internal spring. The knob assembly may include a control knob mounted to the knob switch. The control knob may include an adjustable body mounted to the slidable stem. The adjustable body may include a push body and a central projection that may define a body opening. The push body may be positioned outward of the central projection, The control knob may be a static body disposed within the body opening of the central projection. The control knob may include an outer skirt secured to the forward face. The outer skirt may include an outer projection positioned around the adjustable body and the static body.

### FIELD OF THE DISCLOSURE

The present subject matter relates generally to a cooking appliance, and more particularly to a knob assembly for a cooking appliance.

### BACKGROUND OF THE DISCLOSURE

Knobs are commonly used on a variety of commercial and residential appliances to control an operating condition of the appliance. Knobs are particularly common on cooking appliances, such as stoves or cooktops. Various shapes and sizes can be used depending upon, for example, the intended application, aesthetics, and other factors.

For example, cooking appliances that include a cooktop traditionally have at least one heating element positioned on a panel proximate a cooktop surface for use in heating or cooking an object, such as a cooking utensil, and its contents. The heating element can operate to heat a cooking utensil directly through induction heating or can use another heat source such as electrically resistant coils or gas burners. Commonly, one knob corresponds to one or more heating elements such that rotation of the knob activates, ignites, or otherwise adjusts heat generated at the corresponding heating elements. In order to prevent accidental or inadvertent activation of the corresponding heating elements, many knobs require a compound movement (e.g., a push, a pinch, a squeeze, or the like) to activate or ignite the heating elements from rest (e.g., a state in which no heat is being generated at the heating elements or no fuel is being flowed to the same). For example, a valve or switch box to which the knob is connected can require the knob to be pushed inward before the knob can be rotated (e.g., to adjust the volume of fuel flowed to the heating element or otherwise alter the heat generated at the heating elements).

Certain drawbacks exist with these existing constructions, however. For example, such constructions often require pinching or squeezing efforts from a user before the knob can be rotated. Users having physical limitation, such as decreased hand dexterity, can have difficulties performing these efforts. As another example, existing constructions can still be susceptible to accidental activation that can occur, for instance, when a user leans on the knob and subsequently moves such that the knob is rotated.

Accordingly, a knob assembly that obviates one or more of the above mentioned drawbacks would be beneficial.

### BRIEF DESCRIPTION OF THE DISCLOSURE

Aspects and advantages of the invention will be set forth in part in the following description, or may be obvious from the description, or may be learned through practice of the invention.

In one exemplary aspect of the present disclosure, a knob assembly for an appliance is provided. The appliance may include a surface panel. The surface panel may include a forward face and a rearward face. The surface panel may define a central axis extending from the rearward face to the forward face. The knob assembly may include a knob switch disposed behind the surface panel. The knob switch may include an internal spring and a slidable stem extending through the central axis. The slidable stem may be in forward-biased mechanical communication with the internal spring. The knob assembly may include a control knob mounted to the knob switch. The control knob may include an adjustable body mounted to the slidable stem. The adjustable body may include a push body and a central projection that may define a body opening. The push body may be positioned outward of the central projection. The control knob may include a static body disposed within the body opening of the central projection. The control knob may include an outer skirt secured to the forward face. The outer skirt may include an outer projection positioned around the adjustable body and the static body.

In another exemplary aspect of the present disclosure, a cooking appliance is provided. The cooking appliance may include a cooktop. The cooking appliance may include a heating element mounted to the cooktop. The cooking appliance may include a surface panel mounted to the cooktop forward from the heating element. The surface panel may include a forward face and a rearward face. The surface panel may define a central axis extending from the rearward face to the forward face. The cooking appliance may include a knob switch disposed behind the surface panel. The knob switch may include an internal spring and a slidable stem extending through the central axis. The slidable stem may be in forward-biased mechanical communication with the internal spring. The cooking appliance may include a control knob mounted to the knob switch. The control knob may include an adjustable body mounted to the slidable stem. The adjustable body may include a push body and a central projection that may define a body opening. The push body may be positioned outward of the central projection. The control knob may include a static body disposed within the body opening of the central projection. The control knob may include an outer skirt secured to the forward face. The outer skirt may include an outer projection positioned around the adjustable body and the static body.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a cooking appliance according to exemplary embodiments of the present disclosure.

FIG. 2 provides a perspective view of a control knob of a knob assembly of the exemplary cooking appliance of FIG. 1, wherein the knob assembly is in a static state.

FIG. 3 provides a perspective view of a control knob of a knob assembly of the exemplary cooking appliance of FIG. 1, wherein the knob assembly is in an adjustable state.

FIG. 4 provides an exploded perspective view of a control knob of a knob assembly of the exemplary cooking appliance of FIG. 1.

FIG. 5 provides an exploded perspective view of a control knob of a knob assembly of the exemplary cooking appliance of FIG. 1.

FIG. 6 provides a sectional perspective view of a knob assembly mounted to a control panel of the exemplary cooking appliance of FIG. 1, wherein the knob assembly is in a static state.

FIG. 7 provides a sectional perspective view of a knob assembly mounted to a control panel of the exemplary cooking appliance of FIG. 1, wherein the knob assembly is in an adjustable state.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin (i.e., including values within ten percent greater or less than the stated value). In this regard, for example, when used in the context of an angle or direction, such terms include within ten degrees greater or less than the stated angle or direction (e.g., “generally vertical” includes forming an angle of up to ten degrees in any direction, such as, clockwise or counterclockwise, with the vertical direction V).

The word “exemplary” is used herein to mean “serving as an example, instance, or illustration.” In addition, reference to “an embodiment” or “one embodiment” does not necessarily refer to the same embodiment, although it may. Any implementation described herein as “exemplary” or “an embodiment” is not necessarily to be construed as preferred or advantageous over other implementations.

Except as explicitly indicated otherwise, recitation of a singular processing element (e.g., “a controller,” “a processor,” “a microprocessor,” etc.) is understood to include more than one processing element. In other words, “a processing element” is generally understood as “one or more processing element.” Furthermore, barring a specific statement to the contrary, any steps or functions recited as being performed by “the processing element” or “said processing element” are generally understood to be capable of being performed by “any one of the one or more processing elements.” Thus, a first step or function performed by “the processing element” may be performed by “any one of the one or more processing elements,” and a second step or function performed by “the processing element” may be performed by “any one of the one or more processing elements and not necessarily by the same one of the one or more processing elements by which the first step or function is performed.” Moreover, it is understood that recitation of “the processing element” or “said processing element” performing a plurality of steps or functions does not require that at least one discrete processing element be capable of performing each one of the plurality of steps or functions.

Embodiments of the present disclosure provide a knob assembly having one or more features for preventing accidental engagement, for instance, when a user leans on the knob assembly and subsequently moves such that a control knob of the knob assembly is rotated. Notably, the control knob of the exemplary knob assembly is provided with an outer skirt that is concentrically positioned around an adjustable knob body and a central projection of the control knob. The outer skirt of the control knob is extended, for instance, along an axial direction of the knob assembly, from the control panel. The axial extension of the outer skirt advantageously positions radial surfaces of the adjustable knob body substantially within the axial extension of the outer skirt. Thus, the outer skirt can advantageously prevent blunt objects from being able to depress the adjustable knob body, for instance, along the axial direction, while enabling the ability for a user to depress the adjustable knob body at the push surfaces. In addition, the exemplary knob assembly does not require a user to pinch or squeeze the control knob (e.g., as is often present in existing knob assemblies) to overcome safety mechanisms of the knob assembly. Therefore, users having physical limitation, such as decreased hand dexterity, can advantageously adjust the control knob to activate the appliance without undue stress being applied to the hand of the user.

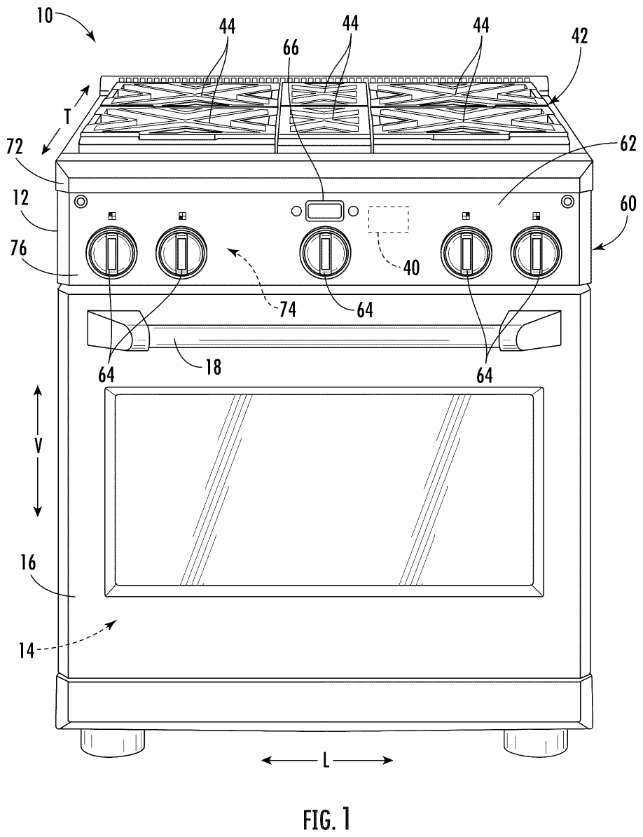

Turning now to the figures, FIG. 1 provides a perspective view of a cooking appliance, such as an oven appliance 10, according to exemplary embodiments of the present disclosure. Generally, oven appliance 10 defines a vertical direction V, a lateral direction L, and a transverse direction T. The vertical direction V, lateral direction L, and transverse direction T are mutually perpendicular and form an orthogonal direction system. As will be understood, oven appliance 10 is provided by way of example only, and the present subject matter may be used in any suitable appliance. Thus, the present disclosure may be used with other oven, range, or cooktop appliance configurations (e.g., configurations that define multiple interior cavities for the receipt of food, include no interior cavities, or are otherwise different than the configuration shown in FIG. 1), as well as other suitable appliances, as would be understood in light of the present disclosure.

Oven appliance 10 includes an insulated cabinet 12 with an interior cooking chamber 14 defined by an interior surface of cabinet 12. Cooking chamber 14 is configured for the receipt of one or more food items to be cooked. Oven appliance 10 includes a door 16 rotatably mounted to cabinet 12 (e.g., with a hinge—not shown). A handle 18 may be mounted to door 16 and may assist a user with opening and closing door 16 in order to access an opening to cooking chamber 14. For example, a user can pull on handle 18 to open or close door 16 and access cooking chamber 14 through the opening. As would be understood, one or more internal heating elements (e.g., baking or broiling heating elements) may be provided within cooking chamber 14 to cook or otherwise heat items therein.

Oven appliance 10 may include a seal between door 16 and cabinet 12 that assist with maintaining heat and cooking fumes within cooking chamber 14 when door 16 is closed, as shown in FIG. 1. One or more parallel glass panes 22 provide for viewing the contents of cooking chamber 14 when door 16 is closed and assist with insulating cooking chamber 14. Optionally, a baking rack may be positioned in cooking chamber 14 for the receipt of food items or utensils containing food items.

In some embodiments, oven appliance 10 includes a cooktop surface 42 having one or more heating elements 44 for use in heating or cooking operations. In exemplary embodiments, cooktop surface 42 includes a metal (e.g., steel) panel on which one or more grates may be supported. In other embodiments, however, cooktop surface 42 includes another suitable material, such as a ceramic glass or another suitable non-metallic material. Heating elements 44 may be various sizes, as shown in FIG. 1, and may employ any suitable method for heating or cooking an object, such as a cooking utensil (e.g., a pot, pan, or the like), and its contents. In one embodiment, for example, heating element uses a heat transfer method, such as electric coils or gas burners, to heat the cooking utensil. In another embodiment, however, heating element 44 uses an induction heating method to heat the cooking utensil directly. In turn, heating element may include a burner element, electric heat element, induction element, or another suitable heating element.

Some embodiments of oven appliance 10 include a controller 40 (e.g., configured to control one or more operations of oven appliance 10). For example, controller 40 may control at least one operation of oven appliance 10 that includes an internal heating element or cooktop heating element 44. Controller 40 may be in communication (via for example a suitable wired or wireless connection) with one or more of heating element(s) 44 and other suitable components of oven appliance 10, as discussed herein. In general, controller 40 may be operable to configure oven appliance 10 (and various components thereof) for cooking. Such configuration may be based, for instance, on a plurality of cooking factors of a selected operating cycle or mode.

By way of example, controller 40 may include one or more memory devices and one or more microprocessors, such as general or special purpose microprocessors operable to execute programming instructions or micro-control code associated with an operating cycle. The memory may represent random access memory such as DRAM, or read only memory such as ROM or FLASH. In one embodiment, the processor executes programming instructions stored in memory. The memory may be a separate component from the processor or may be included onboard within the processor.

Controller 40 may be positioned in a variety of locations throughout oven appliance 10. As illustrated, controller 40 may be located within a user interface 62 of oven appliance 10. In some such embodiments, input/output (“I/O”) signals may be routed between controller 40 and various operational components of oven appliance 10, such as heating element(s) 44, control knobs 64, display component 66, sensors, alarms, or other components as may be provided. For instance, signals may be directed along one or more wiring harnesses that may be routed through cabinet 12. In some embodiments, controller 40 is in communication with user interface assembly 62 and control knobs 64 through which a user may select various operational features and modes and monitor progress of oven appliance 10. In one embodiment, user interface assembly 62 may represent a general purpose I/O (“GPIO”) device or functional block. In one embodiment, user interface assembly 62 may include input components, such as one or more of a variety of electrical, mechanical, or electro-mechanical input devices including rotary dials, push buttons, and touch pads. User interface assembly 62 may include a display component 66, such as a digital or analog display configured to provide operational feedback to a user.

During use of oven appliance 10, the amount of heat delivered by each heating element 44 on cooktop 42 may be controlled by controller 40 and a corresponding knob assembly 60, described in detail below. For instance, knob assembly 60 may include one or more control knobs 64 mounted (e.g., rotatably) on a surface panel 76 of user interface 62 forward from heating elements 44 (e.g., along or relative to the transverse direction T). Each control knob 64 may correspond to a discrete heating element 44.

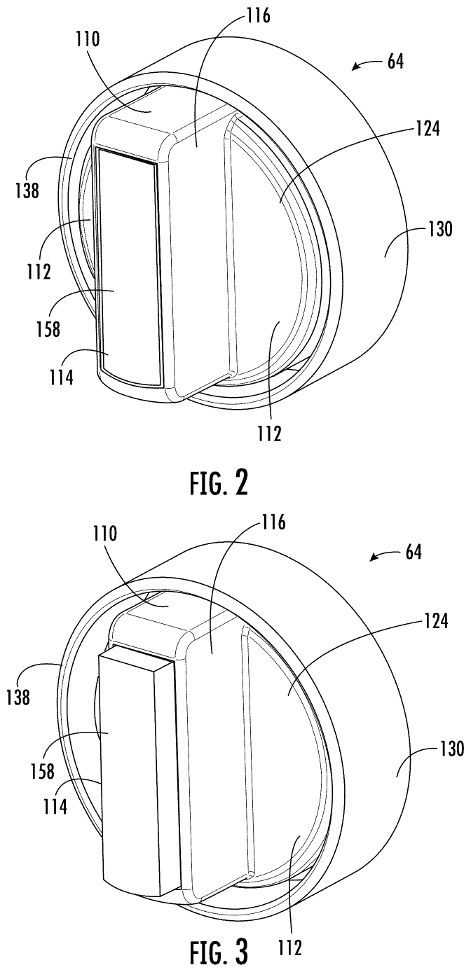

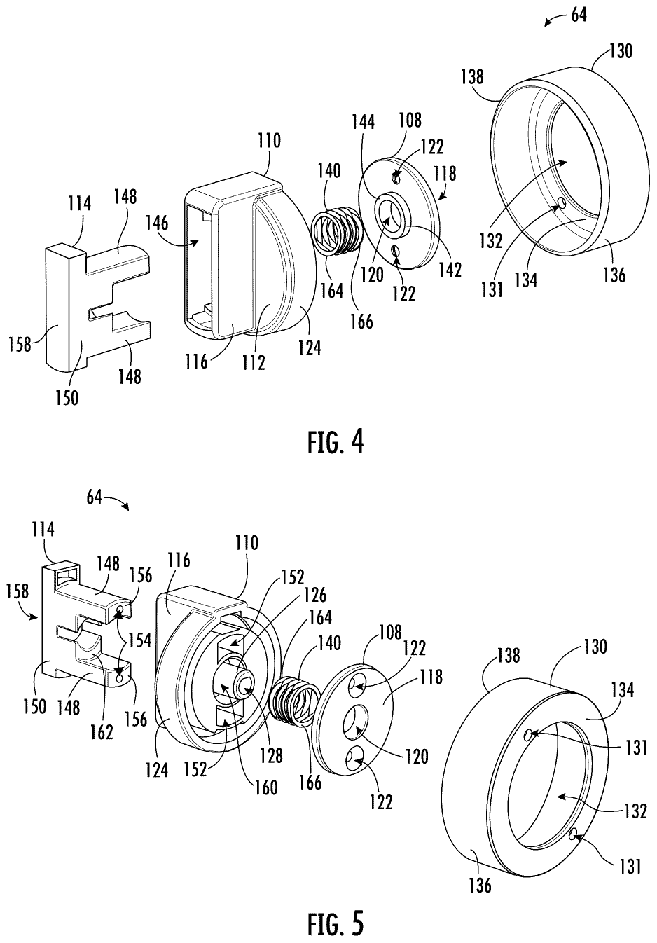

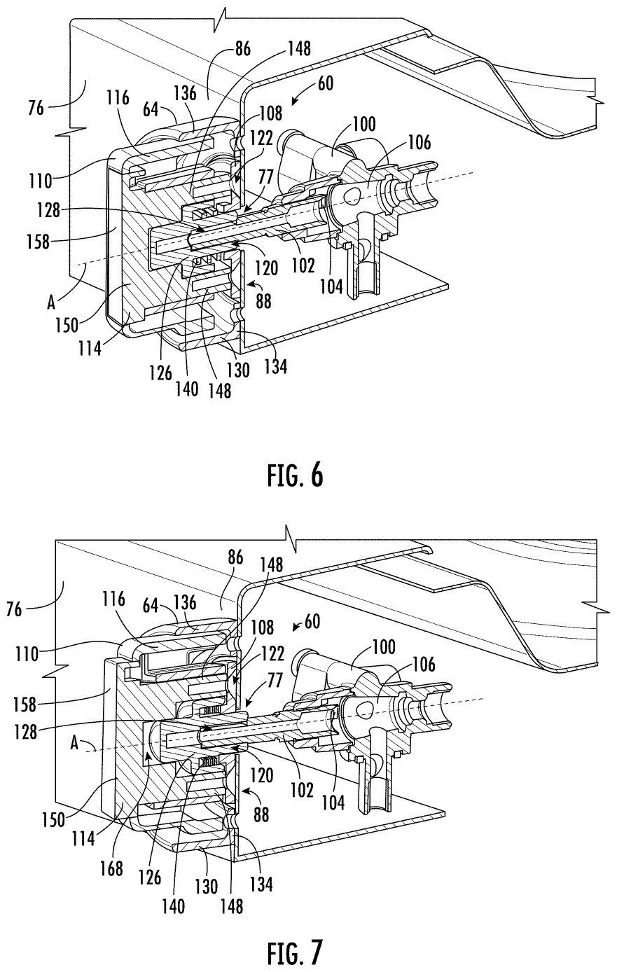

Turning now to FIGS. 2 through 7, various views are provided of a particular knob assembly 60 (e.g., including one control knob 64) and portions thereof, such as might be provided at a particular knob assembly 60 in FIG. 1. FIGS. 2 and 3 provide perspective views of the control knob 64 of the knob assembly 60 in a static state and an adjustable state, respectively. FIGS. 4 and 5 provide exploded perspective views of the control knob 64. FIGS. 6 and 7 provide sectional views of knob assembly 60 in the static state and the adjustable state, respectively.

The knob assembly 60 may include a knob switch 100 and control knob 64, which are connected to each other and mounted on surface panel 76. In some embodiments, surface panel 76 defines one or more axes or openings to permit mechanical or electrical connections between portions of knob assembly 60 or controller 40 (e.g., within cabinet 12). For instance, surface panel 76 may define a central axis A through an opening 77 extending from a rearward face 88 to a forward face 86 of surface panel 76 (e.g., perpendicular to the surface panel 76 or vertical direction V). Knob switch 100 may be disposed behind surface panel 76 while control knob 64 is disposed in front of surface panel 76.

The knob switch 100 may be provided as any suitable mechanism or device configured for detecting, or communicating a signal relating to, the rotational position of the control knob 64. For example, the knob switch 100 may include or be provided as a potentiometer, a digital encoder, or the like. In some exemplary embodiments, the knob switch 100 includes a suitable mechanical valve or electrical switch in communication with a slidable stem 102 and internal spring 104 of knob switch 100. The slidable stem 102 may be extended from a switch body 106 (e.g., through surface panel 76) to form part of a suitable input mechanism for controlling a valve position or detecting and communicating a signal relating to the rotational position of control knob 64. Internal spring 104 may bias slidable stem 102 forward. During use, rotation of control knob 64 and the slidable stem 102 about the central axis A may alternately increase or decrease a voltage signal and, in turn, alternately increase or decrease an output of a heating element (e.g., heating element 44), as would be understood. Moreover, as would further be understood, internal spring 104 may be in forward-biased mechanical communication with the slidable stem 102 to require rearward translation of slidable stem 102 to permit subsequent rotation. Thus, after initially pushing slidable stem 102 rearward, slidable stem 102 may be permitted to rotate freely (e.g., within a predefined angle or circumferential path).

In some embodiments, control knob 64 includes various components that are generally mounted along and about a portion of central axis A (e.g., to direct the rotational position of slidable stem 102). Specifically, control knob 64 may include a support plate 108 that is rotatably mounted about the slidable stem 102 in front of the forward face 86. An adjustable body 110 having or defining push surfaces 112 may be rotationally fixed to the support plate 108 (e.g., while being slidable relative to the same). A static body 114 may be disposed within a central projection 116 of the adjustable body 110.

The support plate 108 may be held in place or otherwise secured to the control knob 64 via one or more mechanical fasteners, such as screws, bolts, or the like. For instance, the support plate 108 may be directly secured to the static body 114 and indirectly (e.g., via the static body 114) secured to the adjustable body 110. When assembled, support plate 108 may be permitted to rotate relative to surface panel 76 while being axially static. In other words, support plate 108 may function to rotate about the central axis A, but maintain a constant axial position relative to the central axis A. In some such embodiments, support plate 108 includes a contact surface 118 disposed on or against forward face 86 about a center hole 120 that is coaxial with central axis A. One or more fastener holes 122 may be defined through the contact surface 118 to permit the mechanical fasteners, such as screws, bolts, or the like, to each extend therethrough.

The adjustable body 110 may generally be disposed in front of support plate 108. Specifically, the adjustable body 110 may be mounted to the slidable stem 102 to move therewith. Thus, the adjustable body 110 may be slidable relative to support plate 108. Moreover, the adjustable body 110 may be rotationally fixed to support plate 108 such that rotation of the adjustable body 110 and slidable stem 102 may also rotate support plate 108. For instance, mechanical fasteners extending through the adjustable body 110 may be rotated by the adjustable body 110 and thereby direct rotation of support plate 108 too.

The adjustable body 110 may include or define a push body 124. The push body 124 may include push surfaces 112 that extend outward, for instance, radially outward, from the slidable stem 102. In particular, push surfaces 112 may be radially spaced apart or outward from slidable stem 102 to permit a user to push the adjustable body 110. A center cylinder 126 of adjustable body 110, which is disposed radially inward from the push body 124, may bridge the radial space between slidable stem 102 and push body 124 (e.g., behind the central projection 116). In certain embodiments, center cylinder 126 extends across the central axis A. Moreover, the center cylinder 126 may provide an attachment surface or structure to connect the adjustable body 110 to the slidable stem 102. For instance, center cylinder 126 may define a slot 128 that is matched to the slidable stem 102. In other words, the shape of slot 128 may form the negative of the profile shape (e.g., a circular or non-circular profile shape) of the slidable stem 102 such that the slot 128 can receive the slidable stem 102 and be rotated by the same.

The control knob 64 may further include an outer skirt 130. The outer skirt 130 may be mounted to the surface panel 76 at the forward face 86 of the surface panel 76. In particular, the outer skirt 130 may define one or more skirt fastener holes 131 for receiving one or more mechanical fasteners, such as screws, bolts, or the like, therethrough. The one or more mechanical fasteners received through the skirt fastener holes 131 may secure or fasten the outer skirt 130 to the forward face 86 of the surface panel 76. The outer skirt 130 may be positioned around the support plate 108. For instance, the outer skirt 130 may define a plate opening 132 at a mount wall 134 that the support plate 108 may be positioned within when assembled. In some exemplary embodiments, the mount wall 134 defines the skirt fastener holes 131. The outer skirt 130 may include an outer projection 136 that extends axially from the mount wall 134. When assembled, the push body 124 of the adjustable body 110 may be disposed within the outer projection 136 of the outer skirt 130. In particular, the outer projection 136 may extend such that a distal edge 138 of the outer projection 136 is positioned forward of the push body 124 relative to the central axis A, for instance, in the static or the adjusted position of the push body 124.

In additional or alternative exemplary embodiments, one or more components of the control knob 64 may include integrated fastening means, such as snaps, tabs, or the like that are configured for further securing or coupling the one or more components of the control knob 64.

When assembled, the adjustable body 110 may be biased forward from or at a point apart from slidable stem 102. For instance, an external spring 140 may be disposed between the support plate 108 and the adjustable body 110. Specifically, the adjustable body 110 may be in forward-biased mechanical communication with external spring 140. The control knob 64 may also include a front projection 142 extended from the support plate 108 to engage the external spring 140. For instance, the external spring 140 may engage or interface with a front surface 144 of the front projection 142. In certain embodiments, the front projection 142 may be formed to the support plate 108 such that the support plate 108 and the front projection 142 together define the center hole 120. As shown, the external spring 140 may be formed or provided as a coiled compression spring (e.g., to bias the adjustable body 110 forward relative to support plate 108). Nonetheless, any suitable spring structure (e.g., leaf spring, sponge spring, torsion spring, etc.) may be provided between the support plate 108 and the adjustable body 110. In turn, external spring 140 may further bias adjustable body 110 toward a static state (e.g., FIGS. 2 and 6), even after a user has axially depressed adjustable body 110 to a rearward adjustable state (e.g., FIGS. 3 and 7) wherein adjustable body 110 and slidable stem 102 may be rotated. Since slidable stem 102 is generally fixed relative to the adjustable body 110, axial movement of the adjustable body 110 between the static and adjustable states may similarly move slidable stem 102 (e.g., relative to surface panel 76 or a portion of the knob switch 100, which houses internal spring 104 and a valve or electronic switch, as is understood).

Separate from adjustable body 110, the static body 114 may be included with knob assembly 60. Specifically, the static body 114 may be disposed within a body opening 146 defined by the central projection 116 of the adjustable body 110, for instance, inward of the push body 124. The static body 114 may include a plurality of mount feet 148 that extend from a head portion 150 of the static body 114 toward the surface panel 76. The plurality of mount feet 148 may each be extended through the body opening 146 and feet apertures 152 defined through the push body 124 such that fastener holes 154 defined through rear surfaces 156 of the plurality of mount feet 148 may align with the fastener holes 122 defined through the support plate 108. In this regard, mechanical fasteners may be extended through the fastener holes 122 and the fastener holes 154 to secure the static body 114 (e.g., directly) and the adjustable body 110 (e.g., indirectly via the static body 114) to the support plate 108.

The static body 114 may be an axially static member that is not permitted to slide with slidable stem 102 relative to surface panel 76. Additionally or alternatively, the static body 114 may define a stop surface 158 that may be disposed flush with or forward from adjustable body 110 (e.g., the entirety of the adjustable body 110 depending on the state of the adjustable body 110). As shown in FIGS. 2 and 6, stop surface 158 may be positioned flush to proud with the central projection 116 of the adjustable body 110 when the adjustable body 110 is in the static state. In particular, the stop surface 158 may be positioned in line with or slightly forward of the distal or forward most edge of the central projection 116 of the adjustable body 110 when the adjustable body 110 is in the static state. As shown in FIGS. 3 and 7, stop surface 158 may be forward of the central projection 116 (e.g., a distal or forward most edge of the central projection 116) of the adjustable body 110 when the adjustable body 110 is in the adjustable state.

The outer skirt 130 and the static body 114 advantageously prevent unintentional or accidental depression of the adjustable body 110 of the knob assembly 60. In particular, the outer projection 136 of the outer skirt 130 and the stop surface 158 of the static body 114 may together prevent a solid mass or a blunt object, such as a user's waist or midsection, an animal's paw, child's hand, or the like, that is moved toward knob assembly 60 from unintentionally or accidentally pushing or applying force (e.g., approximately in the direction of the central axis A) to the push body 124. Notably, the positions of the outer skirt 130 and the static body 114 (e.g., relative to the adjustable body 110) advantageously require force applied to the adjustable body 110 to be localized at portions, such as the push surfaces 112, of the push body 124. In this regard, the adjustable body 110 may only be moved when a user applies localized forced, such as via fingers of the user's hand, to the push surfaces 112.

In certain embodiments, at least a portion of the external spring 140 is positioned around the center cylinder 126. For instance, the push body 124 may define a spring opening 160 around the center cylinder 126. At least a portion of the external spring 140 may be disposed within the spring opening 160 and around the center cylinder 126. The static body 114 may include a spring surface 162 that the external spring 140 may also interface or engage with. The spring surface 162 may be positioned behind the stop surface 158, for instance, such that it is positioned within the body opening 146. In this regard, a front side or edge 164 of the external spring 140 may interface or engage with the spring surface 162 and a rear side or edge 166 of the external spring 140 may interface or engage with the front surface 144 of the front projection 142.

In certain embodiments, 114 is disposed in front of the center cylinder 126 even while being at least a portion of the static body radially bounded by at least a portion of the central projection 116. For instance, the static body 114 may define a rear recess 168 within which the center cylinder 126 is selectively received (e.g., as adjustable body 110 slides forward and rearward towards the static state and the adjustable state, respectively).

During use, a user may activate or ignite a heating element, such as a particular heating element 44 from a rest state by pushing against the push surfaces 112 of a corresponding control knob 64 to move the adjustable body 110 from the static state toward the adjustable state. As the adjustable body 110 is pushed rearward, slidable stem 102 may also slide rearward into the switch body 106 of knob switch 100, thereby compressing internal spring 104 and external spring 140. As shown, the static body 114 and the outer skirt 130 may each remain axially static even as the adjustable body 110 moves rearward to the adjustable state. In the adjustable state, the adjustable body 110 and slidable stem 102 may be permitted to rotate to activate, ignite, or otherwise vary heat generated at the corresponding heating element. Once a user has completed adjustment of the heat (e.g., moved the control knob 64 to a desired setting or rotational position), the user may release the adjustable body 110, thereby allowing external spring 140 to motivate the adjustable body 110 forward (e.g., back towards the static state). In the desired setting or rotational position, the slidable stem 102 may not snap out of the locked position until the control knob 64 is returned to a rest state that corresponds to an OFF position of the particular heating element. Thus, other than in the OFF position, the slidable stem 102 may stay depressed to continue to allow rotation without pushing of the adjustable body 110.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A knob assembly for an appliance, the appliance comprising a surface panel, the surface panel comprising a forward face and a rearward face, the surface panel defining a central axis extending from the rearward face to the forward face, the knob assembly comprising:
a knob switch disposed behind the surface panel, the knob switch comprising an internal spring and a slidable stem extending through the central axis, the slidable stem being in forward-biased mechanical communication with the internal spring; and
a control knob mounted to the knob switch, the control knob comprising:
an adjustable body mounted to the slidable stem, the adjustable body comprising a push body and a central projection defining a body opening, the push body being positioned outward of the central projection,
a static body disposed within the body opening of the central projection, and
an outer skirt secured to the forward face, the outer skirt comprising an outer projection positioned around the adjustable body and the static body.

2. The knob assembly of claim 1, wherein the outer skirt comprises a mount wall,
wherein the outer projection extends from the mount wall to a distal edge of the outer projection, and
wherein the distal edge of the outer projection is positioned in front of the push body.

3. The knob assembly of claim 1, wherein the control knob further comprises
a support plate rotatably mounted about the slidable stem in front of the forward face, and
an external spring disposed between the support plate and the adjustable body, the adjustable body being in forward-biassed mechanical communication with the external spring.

4. The knob assembly of claim 3, wherein the outer skirt comprises a mount wall,
wherein the mount wall defines a plate aperture therethrough, and
wherein the support plate is positioned within the plate aperture.

5. The knob assembly of claim 4, wherein the control knob further comprises
a front projection extending from the support plate,
wherein the static body comprises a spring surface positioned behind the stop surface,
wherein a front side of the external spring is engaged with the spring surface, and
wherein a rear side of the external spring is engaged with the front projection.

6. The knob assembly of claim 1, wherein the adjustable body comprises a center cylinder positioned radially inward from the push body and behind at least a portion of the static body.

7. The knob assembly of claim 6, wherein the static body defines a rear recess receiving the center cylinder therein.

8. The knob assembly of claim 6, wherein the center cylinder defines a slot matched to the slidable stem to be rotated thereby, and
wherein the slidable stem is received within the slot.

9. The knob assembly of claim 1, wherein the static body comprises a head portion and a plurality of mount feet,
wherein the plurality of mount feet extend from the head portion toward the surface panel, and
wherein the plurality of mount feet are positioned within feet apertures defined through the push body.

10. The knob assembly of claim 1, wherein the static body comprises an axially fixed stop surface,
wherein the stop surface is flush to proud with a distal edge of the central projection relative to the central axis in a static state of the knob assembly, and
wherein stop surface is forward of the distal edge of the central projection relative to the central axis in an adjustable state of the knob assembly.

11. A cooking appliance comprising:
a cooktop;
a heating element mounted to the cooktop;
a surface panel mounted to the cooktop forward from the heating element, the surface panel comprising a forward face and a rearward face, the surface panel defining a central axis extending from the rearward face to the forward face;
a knob switch disposed behind the surface panel, the knob switch comprising an internal spring and a slidable stem extending through the central axis, the slidable stem being in forward-biased mechanical communication with the internal spring; and
a control knob mounted to the knob switch, the control knob comprising:
an adjustable body mounted to the slidable stem, the adjustable body comprising a push body and a central projection defining a body opening, the push body being positioned outward of the central projection,
a static body disposed within the body opening of the central projection, and
an outer skirt secured to the forward face, the outer skirt comprising an outer projection positioned around the adjustable body and the static body.

12. The cooking appliance of claim 11, wherein the outer skirt comprises a mount wall,
wherein the outer projection extends from the mount wall to a distal edge of the outer projection, and
wherein the distal edge of the outer projection is positioned in front of the push body.

13. The cooking appliance of claim 11, wherein the control knob further comprises
a support plate rotatably mounted about the slidable stem in front of the forward face, and
an external spring disposed between the support plate and the adjustable body, the adjustable body being in forward-biassed mechanical communication with the external spring.

14. The cooking appliance of claim 13, wherein the outer skirt comprises a mount wall,
wherein the mount wall defines a plate aperture therethrough, and
wherein the support plate is positioned within the plate aperture.

15. The cooking appliance of claim 14, wherein the control knob further comprises
a front projection extending from the support plate,
wherein the static body comprises a spring surface positioned behind the stop surface,
wherein a front side of the external spring is engaged with the spring surface, and
wherein a rear side of the external spring is engaged with the front projection.

16. The cooking appliance of claim 11, wherein the adjustable body comprises a center cylinder positioned radially inward from the push body and behind at least a portion of the static body.

17. The cooking appliance of claim 16, wherein the static body defines a rear recess receiving the center cylinder therein.

18. The cooking appliance of claim 16, wherein the center cylinder defines a slot matched to the slidable stem to be rotated thereby, and
wherein the slidable stem is received within the slot.

19. The cooking appliance of claim 11, wherein the static body comprises a head portion and a plurality of mount feet,
wherein the plurality of mount feet extend from the head portion toward the surface panel, and
wherein the plurality of mount feet are positioned within feet apertures defined through the push body.

20. The cooking appliance of claim 11, wherein the static body comprises an axially fixed stop surface,
wherein the stop surface is flush to proud with a distal edge of the central projection relative to the central axis in a static state of the control knob, and
wherein stop surface is forward of the distal edge of the central projection relative to the central axis in an adjustable state of the control knob.
